(19) United States
(12) Patent Application Publication
(10) Pub. No.: US 2021/0073096 A1
(43) Pub. Date: Mar. 11, 2021

(54) THREE-DIMENSIONAL SPACE MONITORING DEVICE AND THREE-DIMENSIONAL SPACE MONITORING METHOD

(71) Applicant: Mitsubishi Electric Corporation, Tokyo (JP)

(72) Inventor: Yoshiyuki KATO, Tokyo (JP)

(73) Assignee: Mitsubishi Electric Corporation, Tokyo (JP)

(21) Appl. No.: 16/642,727

(22) PCT Filed: Nov. 17, 2017
(86) PCT No.: PCT/JP2017/041487

§ 371 Date: Feb. 27, 2020

(51) Int. Cl. G06F 11/30; G06N 3/08; G05B 19/4061; B25J 19/06

(52) U.S. Cl. CPC G06F 11/3013; G06N 3/08; G06F 11/3058; B25J 19/06; G05B 19/4061

(57) ABSTRACT

A three-dimensional space monitoring device generates a learning result by machine-learning operation patterns of a first monitoring target and a second monitoring target from first measurement information on the first monitoring target and second measurement information on the second monitoring target; generates a first operation space of the first monitoring target and a second operation space of the second monitoring target; calculates a first distance from the first monitoring target to the second operation space and a second distance from the second monitoring target to the first operation space; determines a distance threshold based on the learning result and predicts a possibility of contact between the first monitoring target and the second monitoring target based on the first and second distances and the distance threshold; and executes a process based on the possibility of contact.

### TECHNICAL FIELD

The present invention relates to a three-dimensional space monitoring device, a three-dimensional space monitoring method and a three-dimensional space monitoring program for monitoring a three-dimensional space in which a first monitoring target and a second monitoring target exist (hereinafter referred to also as a “coexistence space”).

### BACKGROUND ART

In recent years, it is becoming increasingly common that a human (hereinafter referred to also as a “worker”) and a machine (hereinafter referred to also as a “robot”) perform collaborative work in a coexistence space in a manufacturing plant or the like.

Patent Reference 1 describes a control device that holds learning information acquired by learning chronological condition (e.g., position coordinates) of a worker and a robot and controls the operation of the robot based on current condition of the worker, current condition of the robot and the learning information.

Patent Reference 2 describes a control device that predicts future positions of a worker and a robot based respectively on current positions and moving speeds of the worker and the robot, judges the possibility of contact between the worker and the robot based on the future positions, and executes a process according to a result of the judgment.

### PRIOR ART REFERENCE

### Patent Reference

Patent Reference 1: Japanese Patent Application Publication No. 2016-159407 (claim 1, Abstract, Paragraph 0008, and FIGS. 1 and 2, for example)

Patent Reference 2: Japanese Patent Application Publication No. 2010-120139 (claim 1, Abstract, and FIGS. 1 to 4, for example)

### SUMMARY OF THE INVENTION

### Problem to be Solved by the Invention

The control device of the Patent Reference 1 stops or decelerates the operation of the robot when the current conditions of the worker and the robot differ from the conditions of the worker and the robot at the time of the learning. However, since this control device does not consider the distance between the worker and the robot, it is incapable of correctly judging the possibility of contact between the worker and the robot. For example, the operation of the robot stops or decelerates even when the worker has moved in a direction in which the worker leaves the robot. Namely, there are cases where the operation of the robot stops or decelerates when the stoppage/deceleration is unnecessary.

The control device of the Patent Reference 2 controls the robot based on the predicted future positions of the worker and the robot. However, the possibility of contact between the worker and the robot cannot be judged correctly when there are multiple types of action of the worker and multiple types of operation of the robot or when there is a great individual difference in the action of the worker. Thus, there are cases where the operation of the robot stops when the stoppage is unnecessary or the operation of the robot does not stop when the stoppage is necessary.

An object of the present invention, which has been made to resolve the above-described problems, is to provide a three-dimensional space monitoring device, a three-dimensional space monitoring method and a three-dimensional space monitoring program with which the possibility of contact between a first monitoring target and a second monitoring target can be judged with high accuracy.

### Means for Solving the Problem

A three-dimensional space monitoring device according to an aspect of the present invention is a device that monitors a coexistence space in which a first monitoring target and a second monitoring target exist, including: a learning unit that generates a learning result by machine-learning operation patterns of the first monitoring target and the second monitoring target from chronological first measurement information on the first monitoring target and chronological second measurement information on the second monitoring target which are acquired by measuring the coexistence space with a sensor unit; an operation space generation unit that generates a virtual first operation space in which the first monitoring target can exist based on the first measurement information and generates a virtual second operation space in which the second monitoring target can exist based on the second measurement information; a distance calculation unit that calculates a first distance from the first monitoring target to the second operation space and a second distance from the second monitoring target to the first operation space; and a contact prediction judgment unit that determines a distance threshold based on the learning result of the learning unit and predicts a possibility of contact between the first monitoring target and the second monitoring target based on the first distance, the second distance and the distance threshold, and executing a process based on the possibility of contact.

A three-dimensional space monitoring method according to another aspect of the present invention is a method of monitoring a coexistence space in which a first monitoring target and a second monitoring target exist, including: a step of generating a learning result by machine-learning operation patterns of the first monitoring target and the second monitoring target from chronological first measurement information on the first monitoring target and chronological second measurement information on the second monitoring target which are acquired by measuring the coexistence space with a sensor unit; a step of generating a virtual first operation space in which the first monitoring target can exist based on the first measurement information and generating a virtual second operation space in which the second monitoring target can exist based on the second measurement information; a step of calculating a first distance from the first monitoring target to the second operation space and a second distance from the second monitoring target to the first operation space; a step of determining a distance threshold based on the learning result and predicting a possibility of contact between the first monitoring target and the second monitoring target based on the first distance, the second distance and the distance threshold; and a step of executing an operation based on the possibility of contact.

### Effect of the Invention

According to the present invention, a possibility of contact between the first monitoring target and the second monitoring target can be judged with high accuracy and it becomes possible to execute an appropriate process based on the possibility of contact.

### BRIEF DESCRIPTION OF THE DRAWINGS

FIG. 1 is a diagram schematically showing a configuration of a three-dimensional space monitoring device and a sensor unit according to a first embodiment.

FIG. 2 is a flowchart showing the operation of the three-dimensional space monitoring device and the sensor unit according to the first embodiment.

FIG. 3 is a block diagram schematically showing an example of a configuration of a learning unit of the three-dimensional space monitoring device according to the first embodiment.

FIG. 4 is a schematic diagram conceptually showing a neural network having weights of three layers.

FIGS. 5A to 5E are schematic perspective views showing examples of skeletal structure of monitoring targets and operation spaces.

FIGS. 6A and 6B are schematic perspective views showing the operation of the three-dimensional space monitoring device according to the first embodiment.

FIG. 7 is a diagram showing a hardware configuration of the three-dimensional space monitoring device according to the first embodiment.

FIG. 8 is a diagram schematically showing a configuration of a three-dimensional space monitoring device and a sensor unit according to a second embodiment.

FIG. 9 is a block diagram schematically showing an example of a configuration of a learning unit of the three-dimensional space monitoring device according to the second embodiment.

### MODE FOR CARRYING OUT THE INVENTION

In the following embodiments, a three-dimensional space monitoring device, a three-dimensional space monitoring method that can be executed by the three-dimensional space monitoring device, and a three-dimensional space monitoring program that causes a computer to execute the three-dimensional space monitoring method will be described with reference to the accompanying drawings. The following embodiments are just examples and a variety of modifications are possible within the scope of the present invention.

In the following embodiments, the description will be given of cases where the three-dimensional space monitoring device monitors a coexistence space in which a “human” (i.e., worker) as a first monitoring target and a “machine or human” (i.e., robot or worker) as a second monitoring target exist. However, the number of monitoring targets existing in the coexistence space may also be three or more.

In the following embodiments, a contact prediction judgment is made in order to prevent contact between the first monitoring target and the second monitoring target. In the contact prediction judgment, whether distance between the first monitoring target and the second monitoring target (in the following description, distance between a monitoring target and an operation space is used) is less than a distance threshold L or not (i.e., whether the first monitoring target and the second monitoring target are closer to each other than the distance threshold L or not) is judged. Then, the three-dimensional space monitoring device executes a process based on the result of this judgment (i.e., contact prediction judgment). This process includes, for example, a process for presenting information for avoiding the contact to the worker and a process for stopping or decelerating the operation of the robot for avoiding the contact.

In the following embodiments, a learning result D2 is generated by machine-learning action patterns of the worker in the coexistence space, and the distance threshold L used for the contact prediction judgment is determined based on the learning result D2. Here, the learning result D2 can include, for example, a “proficiency level” as an index indicating how proficient at work the worker is, a “fatigue level” as an index indicating the level of fatigue of the worker, a “cooperation level” as an index indicating whether or not the progress of the work of the worker coincides with the progress of the work of the partner (i.e., a robot or another worker in the coexistence space), and so forth.

### First Embodiment

### (Three-Dimensional Space Monitoring Device 10)

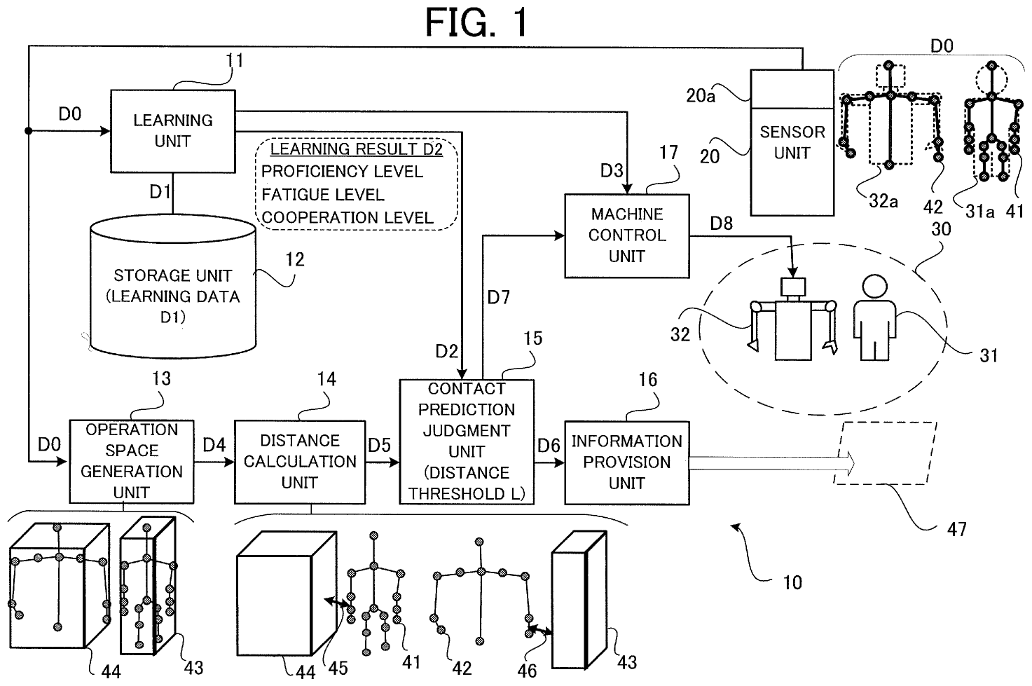

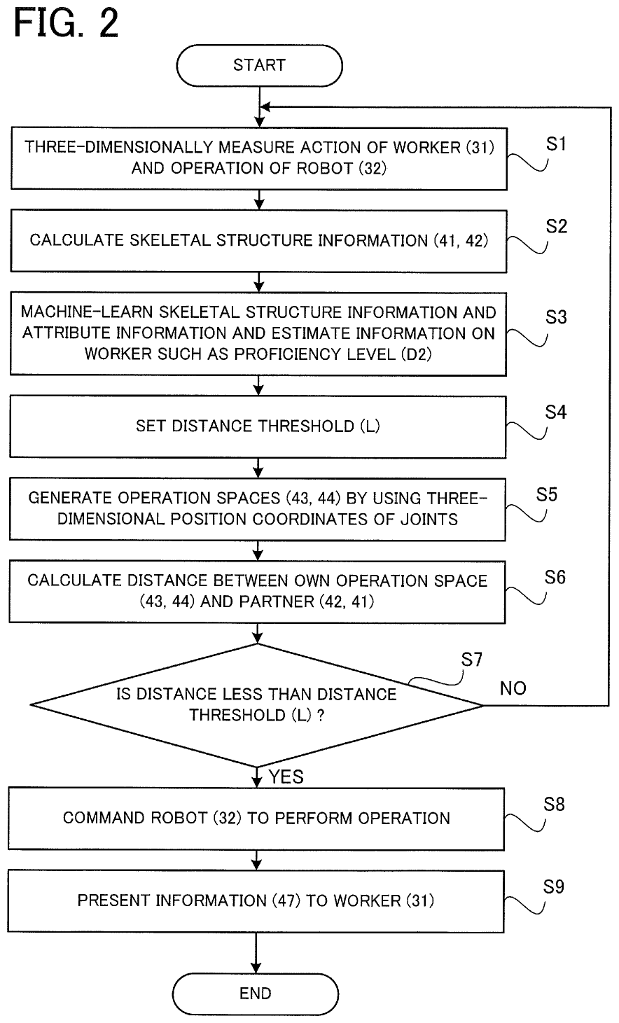

FIG. 1 is a diagram schematically showing a configuration of a three-dimensional space monitoring device 10 and a sensor unit 20 according to a first embodiment. FIG. 2 is a flowchart showing the operation of the three-dimensional space monitoring device 10 and the sensor unit 20. The system shown in FIG. 1 includes the three-dimensional space monitoring device 10 and the sensor unit 20. FIG. 1 shows a case where a worker 31 as the first monitoring target and a robot 32 as the second monitoring target perform collaborative work in a coexistence space 30.

As shown in FIG. 1, the three-dimensional space monitoring device 10 includes a learning unit 11, a storage unit 12 that stores learning data D1 and so on, an operation space generation unit 13, a distance calculation unit 14, a contact prediction judgment unit 15, an information provision unit 16, and a machine control unit 17.

The three-dimensional space monitoring device 10 can execute a three-dimensional space monitoring method. The three-dimensional space monitoring device 10 is, for example, a computer that executes a three-dimensional space monitoring program. The three-dimensional space monitoring method includes, for example:

(1) a step of generating a learning result D2 by machine-learning operation patterns of the worker 31 and the robot 32 from first skeletal structure information 41 based on chronological measurement information (e.g., image information) 31a on the worker 31 acquired by measuring the coexistence space 30 with the sensor unit 20 and second skeletal structure information 42 based on chronological measurement information (e.g., image information) 32a on the robot 32 (steps S1 to S3 in FIG. 2),

(2) a step of generating a virtual first operation space 43 in which the worker 31 can exist from the first skeletal structure information 41 and generating a virtual second operation space 44 in which the robot 32 can exist from the second skeletal structure information 42 (step S5 in FIG. 2),

(3) a step of calculating a first distance 45 from the worker 31 to the second operation space 44 and a second distance 46 from the robot 32 to the first operation space 43 (step S6 in FIG. 2),

(4) a step of determining the distance threshold L based on the learning result D2 (step S4 in FIG. 2),

(5) a step of predicting a possibility of contact between the worker 31 and the robot 32 based on the first distance 45, the second distance 46 and the distance threshold L (step S7 in FIG. 2), and

(6) a step of executing a process based on the predicted possibility of contact between (steps S8 and S9 in FIG. 2).

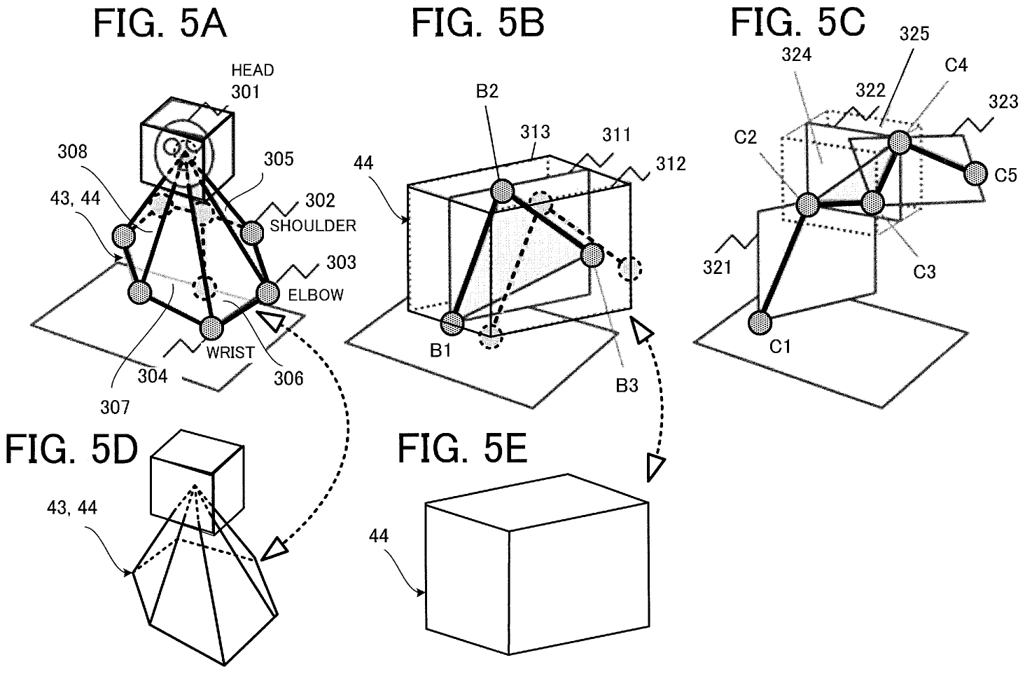

Incidentally, the shapes of the first skeletal structure information 41, the second skeletal structure information 42, the first operation space 43 and the second operation space 44 shown in FIG. 1 are just an example for illustration; more specific examples of the shapes are shown in FIGS. 5A to 5E which will be explained later.

### (Sensor Unit 20)

The sensor unit 20 three-dimensionally measures the action of the worker 31 and the operation of the robot 32 (step S1 in FIG. 2). The sensor unit 20 includes, for example, a distance image camera capable of simultaneously measuring a color image of the worker 31 as the first monitoring target and the robot 32 as the second monitoring target, the distance from the sensor unit 20 to the worker 31, and the distance from the sensor unit 20 to the robot 32 by using infrared rays. In addition to the sensor unit 20, an extra sensor unit arranged at a position different from the sensor unit 20 may also be provided. The extra sensor unit 20 may include a plurality of sensor units arranged at positions different from each other. By providing a plurality of sensor units, dead zones that cannot be measured with the sensor unit can be reduced.

The sensor unit 20 includes a signal processing unit 20a. The signal processing unit 20a converts three-dimensional data of the worker 31 into the first skeletal structure information 41 and converts three-dimensional data of the robot 32 into the second skeletal structure information 42 (step S2 in FIG. 2). Here, the “skeletal structure information” is information formed with three-dimensional position data of joints (or three-dimensional position data of joints and ends of a skeletal structure) when the worker or the robot is regarded as the skeletal structure having the joints. By the conversion into the first and second skeletal structure information, the processing load on the three-dimensional space monitoring device 10 for processing three-dimensional data can be lightened. The sensor unit 20 provides the first and second skeletal structure information 41 and 42 to the learning unit 11 and the operation space generation unit 13 as information D0.

### (Learning Unit 11)

The learning unit 11 machine-learns action patterns of the worker 31 from the first skeletal structure information 41 on the worker 31 and the second skeletal structure information 42 on the robot 32 acquired from the sensor unit 20 and the learning data D1 stored in the storage unit 12 and derives the result of the machine learning as the learning result D2. Similarly, the learning unit 11 may machine-learn operation patterns of the robot 32 (or action patterns of another worker) and derive the result of the machine learning as the learning result D2. In the storage unit 12, training information, learning results, and so forth obtained by machine learning based on the chronological first and second skeletal structure information 41 and 42 on the worker 31 and the robot 32 are stored as the learning data D1 as needed. The learning result D2 can include one or more of the “proficiency level” as the index indicating how proficient at (i.e., accustomed to) work the worker 31 is, the “fatigue level” as the index indicating the level of fatigue (i.e., physical condition) of the worker, and the “cooperation level” as the index indicating whether or not the progress of the work of the worker coincides with the progress of the work of the partner.

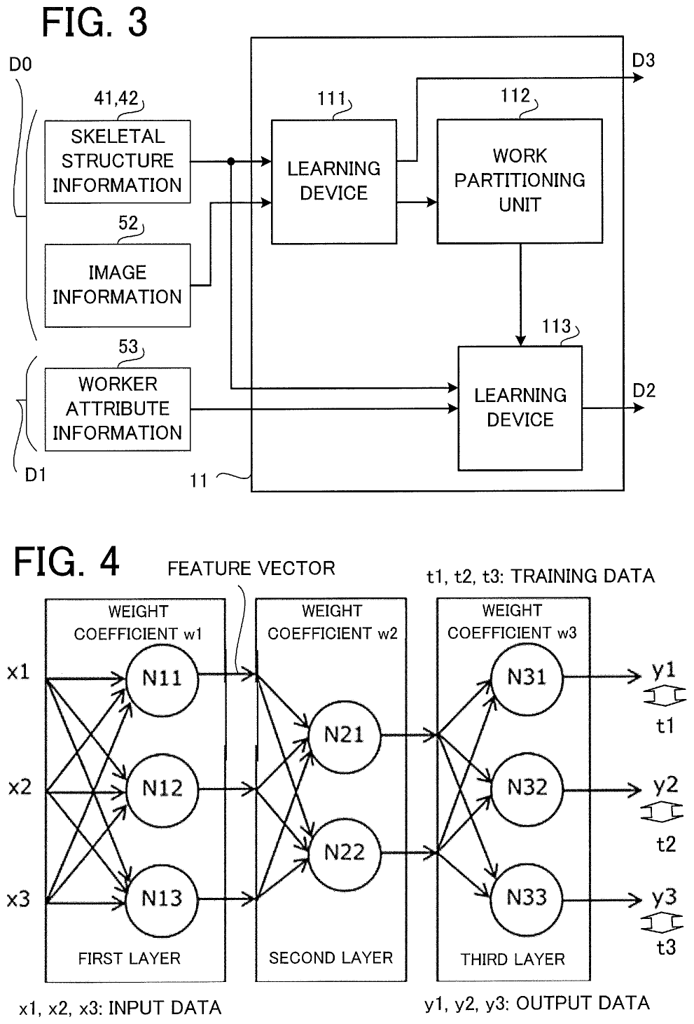

FIG. 3 is a block diagram schematically showing an example of a configuration of the learning unit 11. As shown in FIG. 3, the learning unit 11 includes a learning device 111, a work partitioning unit 112 and a learning device 113.

The description here will be given by taking an example of work in a cell production system in a manufacturing plant. In the cell production system, work is performed by a team of one or a plurality of workers. A chain of work in the cell production system includes multiple types of work stages. For example, a chain of work in the cell production system includes work stages of component installation, screwing, assembly, inspection, packing, etc. Thus, in order to learn action patterns of the worker 31, it is first necessary to partition the chain of work into individual work stages.

The learning device 111 extracts feature values by using differences between chronological images obtained from color image information 52 that is measurement information acquired from the sensor unit 20. For example, when a chain of work is carried out on a work table, shapes of components, tools and products on the work table and so forth differ from work stage to work stage. Therefore, the learning device 111 extracts a change amount of a background image of the worker 31 and the robot 32 (e.g., image of components, tools and products on the work table) and transition information on the change of the background image. The learning device 111 judges with work of which stage the current work coincides, by learning changes in the extracted feature values and changes in the operation patterns in combination with each other. Incidentally, the first and second skeletal structure information 41 and 42 is used for the learning of the operation patterns.

There are various types of methods for the machine learning as the learning performed by the learning device 111. It is possible to employ “unsupervised learning”, “supervised learning”, “reinforcement learning”, etc. as the machine learning.

In the “unsupervised learning”, a great number of background images of the work table are classified into background images of each work stage by learning similar background images from the great number of background images of the work table and clustering the great number of background images. Here, the “clustering” is a method or algorithm for finding a set of similar pieces of data in a great amount of data without preparing training data in advance.

In the “supervised learning”, the learning device 111 is supplied in advance with chronological data on the worker 31's action in each work stage and chronological data on the robot 32's operation in each work stage, thereby learning characteristics of the data on the worker 31's action and comparing a current action pattern of the worker 31 with the characteristics of the action data.

FIG. 4 is a diagram for explaining deep machine learning (deep learning) as a method implementing the machine learning, namely, a schematic diagram showing a neural network including three layers (i.e., a first layer, a second layer and a third layer) respectively having weight coefficients w1, w2 and w3. The first layer has three neurons (i.e., nodes) N11, N12 and N13, the second layer has two neurons N21 and N22, and the third layer has three neurons N31, N32 and N33. When a plurality of inputs x1, x2 and x3 are inputted to the first layer, the neural network performs learning and outputs results y1, y2 and y3. The neurons N11, N12 and N13 of the first layer generate feature vectors from the inputs x1, x2 and x3 and output the feature vectors multiplied by the corresponding weight coefficient w1 to the second layer. The neurons N21 and N22 of the second layer output feature vectors obtained by multiplying the input by the corresponding weight coefficient w2 to the third layer. The neurons N31, N32 and N33 of the third layer output feature vectors obtained by multiplying the input by the corresponding weight coefficient w2 as the results (i.e., output data) y1, y2 and y3. In an error back propagation method (back propagation), the weight coefficients w1, w2 and w3 are updated to optimum values so as to reduce the difference between the results y1, y2 and y3 and the training data t1, t2 and t3.

The “reinforcement learning” is a learning method for determining an action to take by observing the current condition. In the “reinforcement learning”, reward returns upon each action or operation. Thus, it is possible to learn an action or operation that maximizes the reward. For example, as for the distance information on the distance between the worker 31 and the robot 32, the possibility of contact decreases with the increase in the distance. Thus, the operation of the robot 32 can be determined to maximize the reward by giving higher reward with the increase in the distance. Further, since the degree of influence of contact with the worker 31 on the worker 31 is greater with the increase in the magnitude of the acceleration of the robot 32, the reward is set lower with the increase in the magnitude of the acceleration of the robot 32. Furthermore, since the degree of influence of contact with the worker 31 on the worker 31 is greater with the increase in the acceleration and power of the robot 32, the reward is set lower with the increase in the power of the robot 32. Then, control of feeding back the learning result to the operation of the robot 32 is carried out.

By using these learning methods, namely, the “unsupervised learning”, the “supervised learning”, the “reinforcement learning”, etc. in combination, the learning can be performed efficiently and an excellent result (action of the robot 32) can be obtained. A learning device which will be described later also uses these learning methods in combination.

The work partitioning unit 112 partitions a chain of work into individual work stages based on consistency between chronological images acquired by the sensor unit 20, consistency between action patterns, or the like and outputs timing of each break in the chain of work, that is, timing indicating each partitioning position when the chain of work is partitioned into individual work stages.

The learning device 113 estimates the proficiency level, the fatigue level, working speed (i.e., the cooperation level), etc. of the worker 31 by using the first and second skeletal structure information 41 and 42 and worker attribute information 53 as attribute information on the worker 31 stored as the learning data D1 (step S3 in FIG. 2). The “worker attribute information” includes career information on the worker 31 such as the age of the worker 31 and the worker 31's years of experience at the work, physical information on the worker 31 such as body height, body weight and eyesight, work duration and physical condition of the worker 31 on that day, and so forth. The worker attribute information 53 is stored in the storage unit 12 previously (e.g., before starting the work). In the deep learning, a neural network having multilayer structure is used and processing is performed in neural layers having various meanings (e.g., first layer to third layer in FIG. 4). For example, a neural layer for judging the action pattern of the worker 31 judges that the proficiency level at the work is low when measurement data greatly differs from the training data. Further, for example, a neural layer for judging a property of the worker 31 judges that an experience level is low when the worker 31's years of experience are short or the worker 31 is at an advanced age. By assigning weights to judgment results of a great number of neural layers, an overall proficiency level of the worker 31 can finally be obtained.

Even in the same worker 31, when the work duration on that day is long, the fatigue level rises and that affects the worker's power of concentration. Further, the fatigue level varies also depending on the work time of day and the worker's physical condition on that day. In general, while the fatigue level is low and a worker is capable of performing work with high power of concentration just after starting the work or in the morning, the power of concentration drops and the worker becomes more prone to work errors as the working hours extend. Furthermore, it is known that even when the working hours are long, the power of concentration rises inversely just before work hours of the day end.

The obtained proficiency level and fatigue level are used for determining the distance threshold L that is a criterion in estimating the possibility of contact between the worker 31 and the robot 32 (step S4 in FIG. 2).

When it is judged that the proficiency level of the worker 31 is high and the worker's technical skill is at an advanced level, setting the distance threshold L of the distance between the worker 31 and the robot 32 relatively low (namely, setting the distance threshold L at a low value L1) can prevent unnecessary deceleration and stoppage of the operation of the robot 32 and thereby increase working efficiency. In contrast, when it is judged that the proficiency level of the worker 31 is low and the worker's technical skill is at a beginner level, setting the distance threshold L of the distance between the worker 31 and the robot 32 relatively high (namely, setting the distance threshold L at a value L2 higher than the low value L1) can prevent an accidental contact between the inexperienced worker 31 and the robot 32.

When the fatigue level of the worker 31 is high, setting the distance threshold L relatively high (namely, setting the distance threshold L at a high value L3) inhibits the worker 31 and the robot 32 from contacting with each other. In contrast, when the fatigue level of the worker 31 is low and the power of concentration is high, unnecessary deceleration and stoppage of the operation of the robot 32 are prevented by setting the distance threshold L relatively low (namely, setting the distance threshold L at a value L4 lower than the high value L3).

Further, the learning device 113 judges the cooperation level, as the level of cooperation of the worker 31 and the robot 32 at collaborative work, by learning chronological overall relationship between work patterns as the action patterns of the worker 31 and work patterns as the operation patterns of the robot 32 and comparing the current work pattern relationship with work patterns obtained by the learning. When the cooperation level is low, work of one of the worker 31 and the robot 32 can be considered to be behind work of the other, and thus it is necessary to increase the working speed of the robot 32. When the working speed of the worker 31 is low, it is necessary to prompt the worker 31 to speed up the work by presenting effective information to the worker 31.

As above, the learning unit 11 obtains the action patterns, the proficiency level, the fatigue level and the cooperation level of the worker 31, of which calculation by using theory or calculation formulas is difficult, by using the machine learning. Then, the learning device 113 of the learning unit 11 determines the distance threshold L, as a reference value used in estimating the judgment on contact between the worker 31 and the robot 32, by using the obtained proficiency level, fatigue level, etc. By using the determined distance threshold L, the work can be advanced according to the condition and the work status of the worker 31, without unnecessarily decelerating or stopping the robot 32, without making the worker 31 and the robot 32 contact with each other and efficiently.

### (Operation Space Generation Unit 13)

FIGS. 5A to 5E are schematic perspective views showing examples of skeletal structure of monitoring targets and operation spaces. The operation space generation unit 13 generates a virtual operation space according to the shape of each of the worker 31 and the robot 32.

FIG. 5A shows an example of the first or second operation space 43, 44 of the worker 31 or a robot 32 of a dual-armed human type. The worker 31 forms triangular planes (e.g., planes 305-308) peaking at a head 301 by use of the head 301 and joints of shoulders 302, elbows 303 and wrists 304. Then, a space in the shape of a polygonal pyramid (however, the base is not a plane) excluding the vicinity of the head is formed by combining the formed triangular planes. If the head 301 of the worker 31 touches the robot 32, the touch has a great influence on the worker 31. Thus, a space in the vicinity of the head 301 is defined as a space in the shape of a quadrangular prism covering the entire of the head 301. Then, as shown in FIG. 5D, a virtual operation space as a combination of the polygonal pyramid space (i.e., the space excluding the vicinity of the head) and the quadrangular prism space (i.e., the space in the vicinity of the head) is generated. The quadrangular prism space of the head may also be defined as a space in the shape of a polygonal prism other than a quadrangular prism.

FIG. 5B shows an example of the operation space of a robot 32 of a simple arm type. A plane 312 and a plane 313 are generated by moving a plane 311, formed by a skeletal structure including three joints B1, B2 and B3 forming an arm, in a direction perpendicular to the plane 311. The width of the movement is determined in advance according to moving speed of the robot 32, force that the robot 32 applies to another object, size of the robot 32, or the like. In this case, as shown in FIG. 5E, a quadrangular prism formed with the plane 312 and the plane 313 as its top and base is defined as the operation space. However, the operation space may also be defined as a space in the shape of a polygonal prism other than a quadrangular prism.

FIG. 5C shows an example of the operation space of a robot 32 of a multijoint type. A plane 321 is generated from joints C1, C2 and C3, a plane 322 is generated from joints C2, C3 and C4, and a plane 323 is generated from joints C3, C4 and C5. Similarly to the case of FIG. 5B, a plane 324 and a plane 325 are generated by moving the plane 322 in a direction perpendicular to the plane 322, and a quadrangular prism having the plane 324 and the plane 325 as its top and base is generated. Similarly, a quadrangular prism is generated also from each of the plane 321 and the plane 323, and a combination of these quadrangular prisms is defined as the operation space (step S5 in FIG. 2). However, it is also possible to define the operation space as a combination of spaces in shapes of polygonal prisms other than quadrangular prisms.

Incidentally, the shapes and formation procedures of the operation spaces shown in FIGS. 5A to 5E are just examples and a variety of modifications are possible.

### (Distance Calculation Unit 14)

The distance calculation unit 14 calculates, for example, the second distance 46 between the second operation space 44 and a hand of the worker 31 and the first distance 45 between the first operation space 43 and an arm of the robot 32 based on the virtual first and second operation spaces 43 and 44 of the worker 31 and the robot 32 (D4 in FIG. 1) generated by the operation space generation unit 13 (step S6 in FIG. 2). Specifically, in a case of calculating the distance from a tip end part of the arm of the robot 32 to the worker 31, the distance from each of the planes 305 to 308 forming the pyramid part of the first operation space 43 in FIG. 5A to the tip end of the arm of the robot 32 in the perpendicular direction and the distance from each of the planes forming the quadrangular prism (head) part of the first operation space 43 in FIG. 5A to the tip end of the arm in the perpendicular direction are calculated. Similarly, in a case of calculating the distance from the hand of the worker 31 to the robot 32, the distance from each of the planes forming the quadrangular prism of the second operation space 44 to the hand in the perpendicular direction is calculated.

By simulating the shape of the worker 31 or the robot 32 with a combination of simple planes and thereby generating the virtual first and second operation spaces 43 and 44 as described above, the distance to a monitoring target can be calculated with a small number of calculations without the need of providing the sensor unit 20 with a special function.

### (Contact Prediction Judgment Unit 15)

The contact prediction judgment unit 15 judges the possibility of interference between the first and second operation spaces 43 and 44 and the worker 31 or the robot 32 by using the distance threshold L (step S7 in FIG. 2). The distance threshold L is determined based on the learning result D2 that is the result of judgment by the learning unit 11. Thus, the distance threshold L varies depending on the condition (e.g., the proficiency level, the fatigue level, etc.) or the work status (e.g., the cooperation level) of the worker 31.

For example, when the proficiency level of the worker 31 is high, the worker 31 is considered to be accustomed to collaborative work with the robot 32 and have already grasped the working tempo of each other, and thus the possibility of contact with the robot 32 is low even if the distance threshold L is set at a small value. In contrast, when the proficiency level is low, the worker 31 is inexperienced in collaborative work with the robot 32 and improper movement or the like of the worker 31 increases the possibility of contact with the robot 32 compared to cases of experts. Thus, it is necessary to set the distance threshold L at a large value so as to prevent the contact with each other.

Further, even in the same worker 31, the worker 31's power of concentration drops when the physical condition is bad or the fatigue level is low, and thus the possibility of contact becomes high even when the distance to the robot 32 is the same as usual. Therefore, it is necessary to increase the distance threshold L and to notify that there is a possibility of contact with the robot 32 earlier than usual.

### (Information Provision Unit 16)

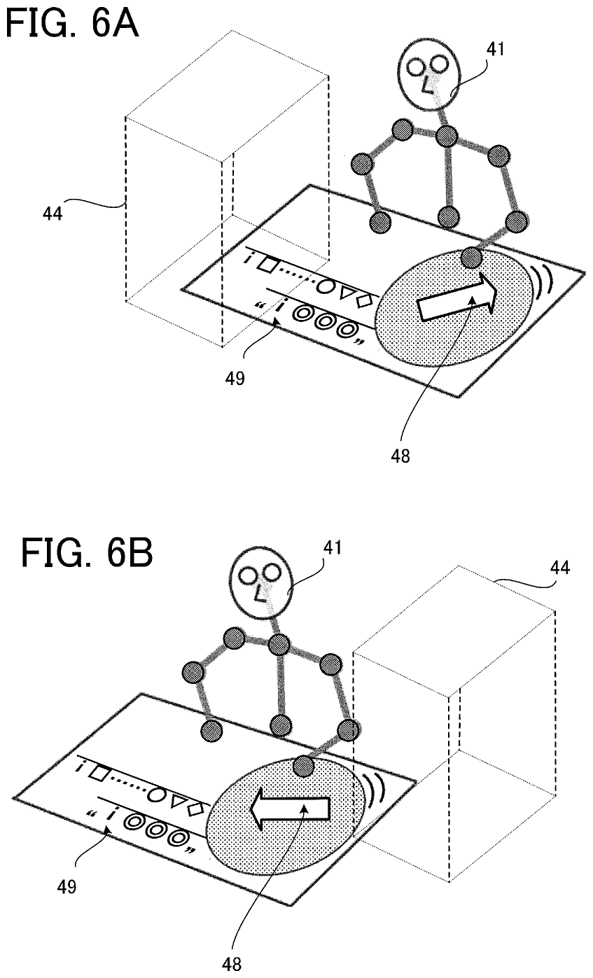

The information provision unit 16 provides information to the worker 31 by using various modals such as display of a figure by use of light, display of characters by use of light, sound, and vibration, that is, by means of a multimodal as a combination of multiple pieces of information using senses such as the five senses of the human. For example, when the contact prediction judgment unit 15 predicts that the worker 31 and the robot 32 will come into contact, projection mapping for warning is performed on the work table. In order to express the warning to be easier to notice and easier to understand, a large arrow 48 in a direction opposite to the operation space 44 is displayed as an animation as shown in FIGS. 6A and 6B to prompt the worker 31 to quickly and intuitively move the hand in the direction of the arrow 48. Further, when the working speed of the worker 31 is slower than the working speed of the robot 32 or below a target working speed in the manufacturing plant, the information provision unit 16 effectively indicates the situation by using a word 49 in a form not disturbing the work and thereby prompts the worker 31 to speed up the work.

### (Machine Control Unit 17)

When the contact prediction judgment unit 15 judges that there is a possibility of contact, the machine control unit 17 outputs an operation command of deceleration, stoppage, withdrawal or the like to the robot 32 (step S8 in FIG. 2). The withdrawal operation is an operation of moving the arm of the robot 32 in a direction opposite to the worker 31 when the worker 31 and the robot 32 are likely to come into contact. The worker 31 sees the operation of the robot 32 and that facilitates the worker 31 to recognize that the worker's own operation is wrong.

### (Hardware Configuration)

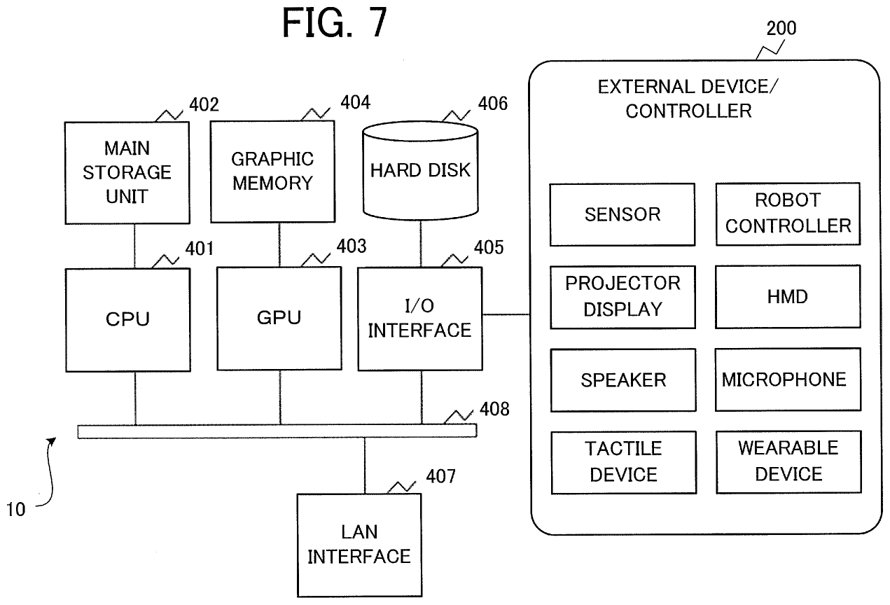

FIG. 7 is a diagram showing a hardware configuration of the three-dimensional space monitoring device 10 according to the first embodiment. The three-dimensional space monitoring device 10 is implemented as an edge computer in a manufacturing plant, for example. Alternatively, the three-dimensional space monitoring device 10 is implemented as a computer embedded in manufacturing equipment close to the working field.

The three-dimensional space monitoring device 10 includes a CPU (Central Processing Unit) 401 as a processor as an information processing means, a main storage unit (e.g., memory) 402 as an information storage means, a GPU (Graphics Processing Unit) 403 as an image information processing means, a graphic memory 404 as an information storage means, an I/O (Input/Output) interface 405, a hard disk 406 as an external storage device, a LAN (Local Area Network) interface 407 as a network communication means, and a system bus 408.

Further, an external device/controller 200 includes a sensor unit, a robot controller, a projector display, an HMD (Head-Mounted Display), a speaker, a microphone, a tactile device, a wearable device, and so forth.

The CPU 401, as a unit for executing programs such as a machine learning program stored in the main storage unit 402, executes a series of processes shown in FIG. 2. The GPU 403 generates a two-dimensional or three-dimensional graphic image to be displayed by the information provision unit 16 to the worker 31. The generated image is stored in the graphic memory 404 and outputted to devices in the external device/controller 200 via the I/O interface 405. The GPU 403 can be utilized also for speeding up the processing of machine learning. The I/O interface 405 is connected to the hard disk 406 storing the learning data and the external device/controller 200, and performs data conversion for controlling or communicating with various sensor units, the robot controller, the projector, the display, the HMD, the speaker, the microphone, the tactile device and the wearable device. The LAN interface 407 is connected to the system bus 408, communicates with an ERP (Enterprise Resources Planning), an MES (Manufacturing Execution System) or a field device in the plant, and is used for acquiring worker information, controlling devices, and so forth.

The three-dimensional space monitoring device 10 shown in FIG. 1 can be implemented by using the main storage unit 402 or the hard disk 406 storing the three-dimensional space monitoring program as software and the CPU 401 executing the three-dimensional space monitoring program (e.g., computer). The three-dimensional space monitoring program can be provided in the form of a program stored in an information recording medium, and also by means of downloading via the Internet. In this case, the learning unit 11, the operation space generation unit 13, the distance calculation unit 14, the contact prediction judgment unit 15, the information provision unit 16 and the machine control unit 17 in FIG. 1 are implemented by the CPU 401 executing the three-dimensional space monitoring program. It is also possible to implement part of the learning unit 11, the operation space generation unit 13, the distance calculation unit 14, the contact prediction judgment unit 15, the information provision unit 16 and the machine control unit 17 shown in FIG. 1 by the CPU 401 executing the three-dimensional space monitoring program. Further, it is also possible to implement the learning unit 11, the operation space generation unit 13, the distance calculation unit 14, the contact prediction judgment unit 15, the information provision unit 16 and the machine control unit 17 shown in FIG. 1 by a processing circuit.

### (Effect)

As described above, according to the first embodiment, the possibility of contact between the first monitoring target and the second monitoring target can be judged with high accuracy.

Further, according to the first embodiment, the distance threshold L is determined based on the learning result D2, and thus the possibility of contact between the worker 31 and the robot 32 can be predicted appropriately according to the condition (e.g., the proficiency level, the fatigue level, etc.) and the work status (e.g., the cooperation level) of the worker 31. Therefore, situations in which the stoppage, deceleration or withdrawal of the robot 32 occurs when it is unnecessary can be reduced and the stoppage, deceleration or withdrawal of the robot 32 can be carried out reliably when it is necessary. Further, situations in which attention-drawing information is provided to the worker 31 when it is unnecessary can be reduced and the attention-drawing information can be provided to the worker 31 reliably when it is necessary.

Furthermore, according to the first embodiment, the distance between the worker 31 and the robot 32 is calculated by using the operation spaces, and thus the number of calculations can be reduced and the time necessary for the judgment on the possibility of contact between can be shortened.

### Second Embodiment

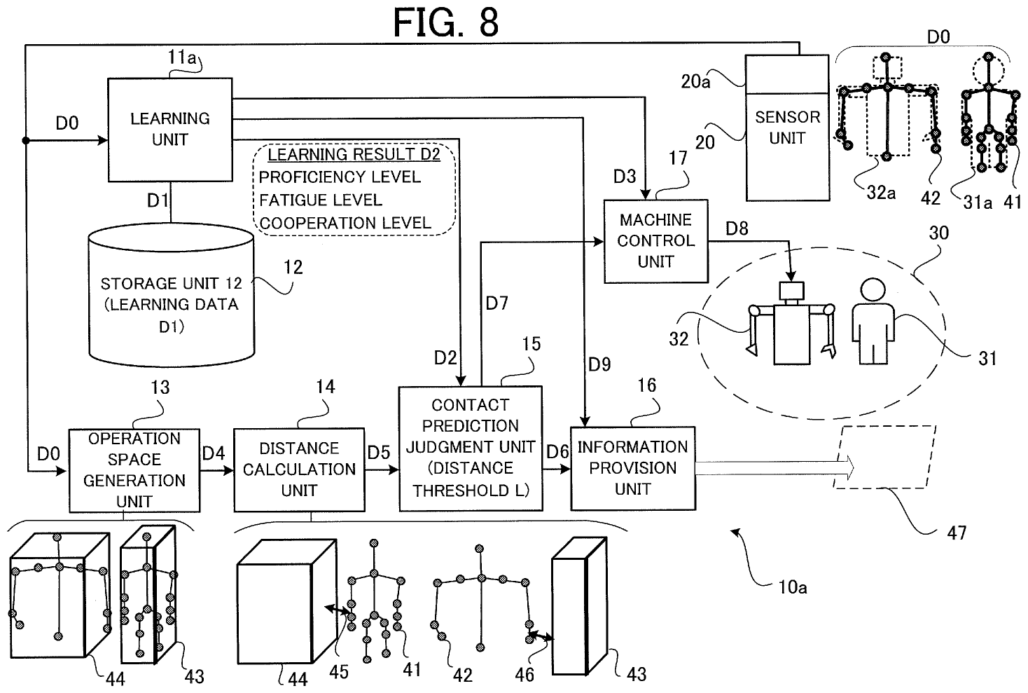

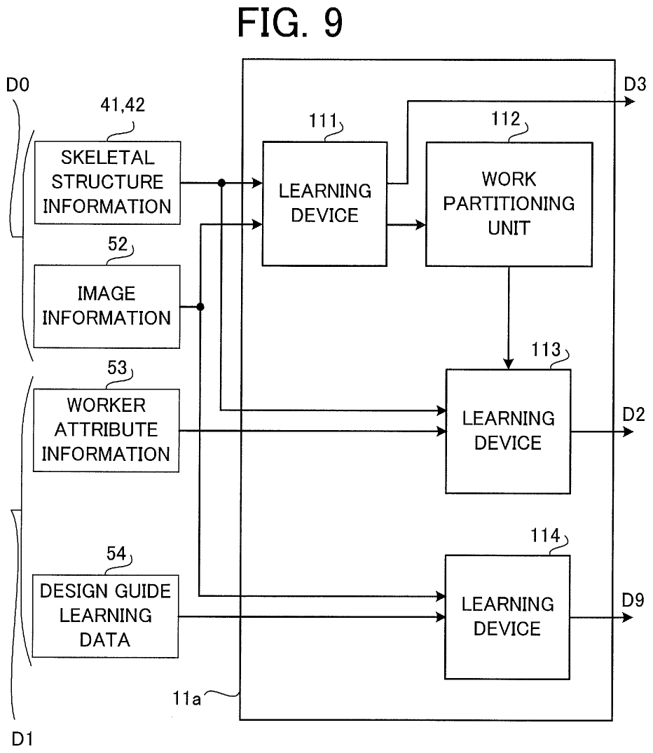

FIG. 8 is a diagram schematically showing a configuration of a three-dimensional space monitoring device 10a and a sensor unit 20 according to a second embodiment. In FIG. 8, each component identical or corresponding to a component shown in FIG. 1 is assigned the same reference character as that in FIG. 1. FIG. 9 is a block diagram schematically showing an example of a configuration of a learning unit 11a of the three-dimensional space monitoring device 10a according to the second embodiment. In FIG. 9, each component identical or corresponding to a component shown in FIG. 3 is assigned the same reference character as that in FIG. 3. The three-dimensional space monitoring device 10a according to the second embodiment differs from the three-dimensional space monitoring device 10 according to the first embodiment in that the learning unit 11a further includes a learning device 114 and the information provision unit 16 provides information based on a learning result D9 from the learning unit 11a.

Design guide learning data 54 shown in FIG. 9 is learning data storing basic rules of design that is easily recognizable to the worker 31. The design guide learning data 54 is, for example, learning data D1 storing color schemes easy to notice for the worker 31, combinations of a background color and a foreground color easy to distinguish for the worker 31, the amount of characters easy to read for the worker 31, the size of characters easy to recognize for the worker 31, the speed of animation easy to understand for the worker 31, and so forth. For example, the learning device 114 uses “supervised learning” and thereby determines an expression means or expression method easy to recognize for the worker 31, depending on the worker 31's working environment, from the design guide learning data 54 and the image information 52.

For example, the learning device 114 uses the following rules 1 to 3 as basic rules of using color when information is presented to the worker 31:

(Rule 1) Blue means “No problem”.
(Rule 2) Yellow means “Attention”.
(Rule 3) Red means “Warning”.
Accordingly, the learning device 114 receives input of types of information to be provided and performs learning, thereby deriving recommended color that should be used.

Further, when projection mapping is preformed onto a work table of dark color (i.e., color close to black) such as green or gray, white-based bright color is used for characters to increase the contrast, and thus the learning device 114 can make the display easy to recognize. The learning device 114 is also capable of deriving the most preferable character color (foreground color) by performing learning from color image information on the work table (background color). In contrast, when the color of the work table is white-based bright color, the learning device 114 is also capable of deriving black-based character color.

As to the size of characters displayed in projection mapping or the like, in a case that warning is displayed, it is necessary to use large characters so that the characters can be recognized at a glance. Therefore, the learning device 114 learns by receiving input of types of display content or the size of the work table on which the display is made, thereby determining the character size suitable for the warning. In contrast, in cases of displaying work instructions or a manual, the learning device 114 derives the optimum size of characters such that all the characters fit in a display region.

As described above, according to the second embodiment, learning color information, character size or the like for display is pertained by using the learning data of design rules, and therefore it is possible to select an information expression method that facilitates intuitive recognition by the worker 31 even if the environment changes.

Regarding respects other than the above, the second embodiment is the same as the first embodiment.

### DESCRIPTION OF REFERENCE CHARACTERS

10, 10a: three-dimensional space monitoring device, 11: learning unit, 12: storage unit, 12a: learning data, 13: operation space generation unit, 14: distance calculation unit, 15: contact prediction judgment unit, 16: information provision unit, 17: machine control unit, 20: sensor unit, 30: coexistence space, 31: worker (first monitoring target), 31a: image of worker, 32: robot (second monitoring target), 32a: image of robot, 41: first skeletal structure information, 42: second skeletal structure information, 43, 43a: first operation space, 44, 44a: second operation space, 45: first distance, 46: second distance, 47: display, 48: arrow, 49: message, 111: learning device, 112: work partitioning unit, 113: learning device, 114: learning device.

1. A three-dimensional space monitoring device that monitors a coexistence space in which a first monitoring target that is a worker and a second monitoring target exist, comprising:
a processor to execute a program; and
a memory to store the program which, when executed by the processor, performs
a process of generating a learning result including a proficiency level of the worker and a fatigue level of the worker by machine-learning operation patterns of the first monitoring target and the second monitoring target from chronological first measurement information on the first monitoring target and chronological second measurement information on the second monitoring target which are acquired by measuring the coexistence space with a sensor;
a process of generating a virtual first operation space in which the first monitoring target can exist based on the first measurement information and generating a virtual second operation space in which the second monitoring target can exist based on the second measurement information, the first operation space including a space in a shape of a polygonal prism covering an entire of a head of the worker and another space in a shape of a polygonal pyramid peaking at the head;
a process of calculating a first distance from the first monitoring target to the second operation space and a second distance from the second monitoring target to the first operation space;
a process of determining a distance threshold based on the learning result so that the distance threshold decreases as the proficiency level is higher and increases as the proficiency level is lower and the distance threshold decreases as the fatigue level is lower and increases as the fatigue level is higher and predicting a possibility of contact between the first monitoring target and the second monitoring target based on the first distance, the second distance and the distance threshold; and
a process of executing a process based on the possibility of contact.

2. The three-dimensional space monitoring device according to claim 1, wherein
the learning result is generated by machine-learning the operation patterns from first skeletal structure information on the first monitoring target generated based on the first measurement information and second skeletal structure information on the second monitoring target generated based on the second measurement information, and
the first operation space is generated from the first skeletal structure information and the second operation space is generated from the second skeletal structure information.

3. The three-dimensional space monitoring device according to claim 1, wherein the second monitoring target is a robot.

4. The three-dimensional space monitoring device according to claim 1, wherein the second monitoring target is another worker.

5. The three-dimensional space monitoring device according to claim 1, wherein the learning result further includes a cooperation level of the worker.

6. The three-dimensional space monitoring device according to claim 3, wherein
higher reward is given as the first distance increases,
higher reward is given as the second distance increases,
lower reward is given as magnitude of acceleration of the robot increases, and
lower reward is given as power of the robot increases.

7. The three-dimensional space monitoring device according to claim 1,
wherein the program which, when executed by the processor, performs a process of executing the provision of the information to the worker as the process based on the possibility of contact.

8. The three-dimensional space monitoring device according to claim 7, wherein the program which, when executed by the processor, performs a process of determining a color scheme easy to notice for the worker, a combination of a background color and a foreground color easy to distinguish for the worker, an amount of characters easy to read for the worker, and size of characters easy to recognize for the worker, in regard to display information provided to the worker, based on the learning result.

9. The three-dimensional space monitoring device according to claim 3,
wherein the program which, when executed by the processor, performs a process of executing the control of the robot as the process based on the possibility of contact.

10. The three-dimensional space monitoring device according to claim 2, wherein the program which, when executed by the processor, performs
a process of generating the first operation space by using a first plane determined by three-dimensional position data of joints included in the first skeletal structure information, and
a process of generating the second operation space by moving a second plane determined by three-dimensional position data of joints included in the second skeletal structure information in a direction perpendicular to the second plane.

11. A three-dimensional space monitoring method of monitoring a coexistence space in which a first monitoring target that is a worker and a second monitoring target exist, comprising:
generating a learning result including a proficiency level of the worker and a fatigue level of the worker by machine-learning operation patterns of the first monitoring target and the second monitoring target from chronological first measurement information on the first monitoring target and chronological second measurement information on the second monitoring target which are acquired by measuring the coexistence space with a sensor;
generating a virtual first operation space in which the first monitoring target can exist based on the first measurement information and generating a virtual second operation space in which the second monitoring target can exist based on the second measurement information, the first operation space including a space in a shape of a polygonal prism covering an entire of a head of the worker and another space in a shape of a polygonal pyramid peaking at the head;
calculating a first distance from the first monitoring target to the second operation space and a second distance from the second monitoring target to the first operation space;
determining a distance threshold based on the learning result so that the distance threshold decreases as the proficiency level is higher and increases as the proficiency level is lower and the distance threshold decreases as the fatigue level is lower and increases as the fatigue level is higher and predicting a possibility of contact between the first monitoring target and the second monitoring target based on the first distance, the second distance and the distance threshold; and
executing an operation based on the possibility of contact.

12. (canceled)
